(19) United States
(12) Patent Application Publication
(10) Pub. No.: US 2015/0010037 A1
(43) Pub. Date: Jan. 8, 2015

(54) RESTRICTIONS ON THE VALIDITY OF THERMAL CONDITIONS AT A POROUS FLUID INTERFACE AND ITS APPLICATIONS

(71) Applicants: Kambiz Vafai, Mission Viejo, CA (US); Kun Yang, Hubel (CN)

(72) Inventors: Kambiz Vafai, Mission Viejo, CA (US); Kun Yang, Hubel (CN)

(21) Appl. No.: 13/935,659

(22) Filed: Jul. 5, 2013

(51) Int. Cl. G01K 17/06

(52) U.S. Cl. CPC G01K 17/06
USPC 374/29

(57) ABSTRACT

A method and system for analyzing variant thermal conditions at the porous-fluid interface under LTNE condition is disclosed. Exact solutions can be derived for both the fluid and solid temperature distributions for the most fundamental forms of thermal conditions at the interface between a porous medium and a fluid under LTNE conditions and the relationships between these solutions are obtained. The range of validity of all the models can be analyzed. Also, a critical non-dimensional half height of the porous media is determined, below which the LTE condition within porous region is considered to be valid. Furthermore, the range of validity of the LTE condition can be obtained based on the introduction of a critical parameter.

### CROSS-REFERENCE TO PATENT APPLICATIONS

This patent application is a continuation of U.S. Nonprovisional patent application Ser. No. 13/590,435, entitled “Manipulating Heat Flux Bifurcation and Dispersion Inside Porous Media for Heat Transfer Control,” which was filed on Aug. 21, 2012 and is incorporated herein by reference in its entirety. U.S. Nonprovisional patent application Ser. No. 13/590,435 claims priority to U.S. Provisional Patent Application Ser. No. 61/598,060, which was filed on Feb. 13, 2012. This patent application therefore traces its priority date to the Feb. 13, 2012 filing date of U.S. Provisional Patent Application Ser. No. 61/598,060, and further incorporates by reference U.S. Provisional Patent Application Ser. No. 61/598,060 in its entirety.

### FIELD OF THE INVENTION

Embodiments are generally related to convective heat transfer in a porous medium. Embodiments also relate to method and system for analyzing variant thermal conditions at the porous-fluid interface under Local Thermal Non-Equilibrium (LTNE) condition. Embodiments are additionally related to an exact solution for restrictions on validity of thermal conditions at a porous fluid interface.

### BACKGROUND

Due to its wide range of engineering applications, convective heat transfer in porous media has gained increased interest in recent years. These applications include geothermal engineering, heat pipes, solid matrix heat exchangers, electronics cooling, enhanced oil recovery, thermal insulation, and chemical reactors. Among which, thermal convection in composite systems is an important aspect. This system consists partly of a porous region and partly of an open region. One example is a channel with a partially filled porous medium. Poulikakos and Kazmierczak studied fully developed forced convection in a channel where the porous matrix was attached at the channel wall but did not extent throughout the channel. See Poulikakos, D., and Kazmierczak, M., 1987, “Forced Convection in A Duct Partially Filled with A Porous Material,” ASME Journal of Heat Transfer, 109, pp. 653-662.

The results showed that there was a critical value of porous region thickness at which the Nusselt number reaches a minimum. Chikh, S., Boumedien, A., Bouhadef, K., and Lauriat, G., 1995, “Analytical Solution of Non-Darcian Forced Convection in An Annular Duct Partially Filled With A Porous Medium,” International Journal of Heat and Mass Transfer, 38(9), pp. 1543-1551, investigated forced convection between two concentric cylinders where the inner cylinder is exposed to a constant heat flux, a porous layer is attached to the inner cylinder, and the porous material does not extend across the full annulus. It was also found that there exists a critical thickness of the porous layer at which heat transfer is minimum in the case of low thermal conductivity materials; however, this was not observed for the highly conducting materials. Alkam, M. K., and Al-Nimr, M. A., 1999, “Improving The Performance of Double-Pipe Heat Exchangers By Using Porous Substrates,” International Journal of Heat and Mass Transfer, 42(19), pp. 3609-3618, presented a method to improve the thermal performance of a conventional concentric tube heat exchanger by inserting high-thermal conductivity porous substrates on both sides of the inner tube wall.

Pavel, B. I., and Mohamad, A. A., 2004, “An Experimental and Numerical Study on Heat Transfer Enhancement for Gas Heat Exchangers Fitted With Porous Media,” International Journal of Heat and Mass Transfer, 47(23), pp. 4939-4952, numerically investigated heat transfer enhancement in a pipe or a channel with the porous medium partially filling the core of the conduit. It was found that this method can enhance the rate of heat transfer, while the pressure drop is much less than that for a conduit fully filled with a porous medium. Pavel and Mohamad [5] experimentally investigated the problem of air flowing inside a pipe when different porous media are emplaced at the core of the pipe. The results showed that a partial filling has the advantage of a comparable increase in the Nusselt number and a smaller increase in the pressure drop.

Kim et al. numerically investigated forced convection in a circular pipe partially filled with a porous medium, which included two types of configurations (in two separate cases). It was found that there exists a critical porous layer thickness where the Nu reaches a minimum in one case and a maximum for another case. Satyamurty and Bhargavi studied forced convection in the thermally developing region of a channel where a partially filled porous medium was attached to one wall only. Kuznetsov has obtained some solutions for the velocity and temperature distributions for few composite systems. See Kim, W. T., Hong, K. H., Jhon, M. S., VanOsdol, J. G., and Smith, D. H., 2003, “Forced Convection in A Circular Pipe with A Partially Filled Porous Medium,” Journal of Mechanical Science and Technology, 17(10), pp. 1583-1595, Satyamurty, V. V., and Bhargavi, D., 2010, “Forced Convection In Thermally Developing Region of A Channel Partially Filled With A Porous Material And Optimal Porous Fraction,” International Journal of Thermal Sciences, 49(2), pp. 319-332 and Kuznetsov, A. V., 2000, “Analytical Studies of Forced Convection in Partly Porous Configurations,” Handbook of Porous Media, K. Vafai, ed., Dekker, New York, pp. 269-312.

Different types of interfacial conditions between a porous medium and a fluid layer have been presented in the literature. Beavers, G. S., and Joseph, D. D., 1967, “Boundary Conditions at A Naturally Permeable Wall,” J. Fluid Mech., 30(1), pp. 197-207, first presented a velocity interfacial condition based on a slip velocity proportional to the exterior velocity gradient which was shown to be in reasonable agreement with experimental results. The above-mentioned references utilized continuity in both the temperature and heat flux at the interface. Vafai and Thiyagaraja presented a detailed analytical solution for the velocity and temperature distributions, as well as the Nusselt number distribution, for three general and fundamental interfaces, namely, the interface between two different porous media, the interface between a fluid region and a porous medium, and the interface between an impermeable medium and a porous medium. See Vafai, K., and Thiyagaraja, R., 1987, “Analysis of Flow and Heat Transfer at the Interface Region of a Porous Medium,” International Journal of Heat and Mass Transfer, 30, pp. 1391-1405.

Vafai, K., and Kim, S., 1990, “Fluid Mechanics of the Interface Region between a Porous Medium and a Fluid Layer—An Exact Solution,” International Journal of Heat and Fluid Flow, 11, pp. 254-256, first derived an exact solution for the fluid mechanics of the interface region between a porous medium and a fluid layer, accounting for both boundary and inertial effects. Alazmi and Vafai comprehensively analyzed five fundamental hydrodynamic interface conditions and four thermal interface conditions. It was shown that the variance within different models have a negligible effect on the results for most practical applications. See Alazmi, B., and Vafai, K., 2001, “Analysis of Fluid Flow and Heat Transfer Interfacial Conditions between a Porous Medium and a Fluid Layer,” International Journal of Heat and Mass Transfer, 44, pp. 1735-1749.

There are two primary ways for representing heat transfer in a porous medium: Local Thermal Equilibrium (LTE) model and LTNE model. The LTE model is more convenient to use and is utilized by the above-mentioned references. However, the temperature difference between the fluid and solid phases within the porous media may be significant and the assumption of local thermal equilibrium is not valid for some applications. Therefore, the LTNE model has been analyzed in the following references. See Amiri, A., and Vafai. K., 1994, “Analysis of Dispersion Effects and Non-Thermal Equilibrium Non-Darcian, Variable Porosity Incompressible Flow through Porous Medium,” International Journal of Heat and Mass Transfer, 37, pp. 939-954, Amiri, A., and Vafai, K., 1998, “Transient Analysis of Incompressible Flow Through A Packed Bed,” Int. J. Heat Mass Transfer, 41, pp. 4259-4279, Lee, D. Y., and Vafai, K., 1999, “Analytical Characterization and Conceptual Assessment Of Solid And Fluid Temperature Differentials In Porous Media,” hit. J. Heat Mass Transfer, 42, pp. 423-435, Marafie, A., and Vafai, K., 2001, “Analysis of Non-Darcian effects on Temperature Differentials in Porous Media,” International Journal of Heat and Mass Transfer, 44, pp. 4401-4411 and Alazmi, B., and Vafai, K., 2002, “Constant Wall Heat Flux Boundary Conditions in Porous Media under Local Thermal Non-Equilibrium Conditions,” Int. J. Heat Mass Transfer, 45, pp. 3071-3087.

Because there are two regions with different temperatures, namely the solid and fluid phase temperatures of the porous region and the fluid temperature of the fluid region, the use of the LTNE model requires an additional thermal interfacial condition. Ochoa-Tapia, J. A., and Whitaker, S., 1997, “Heat transfer at the boundary between a porous medium and a homogeneous fluid,” Int. J. Heat Mass Transfer, 40(11), pp. 2691-2707, developed the heat flux jump conditions between a porous medium and a homogeneous fluid based on a volume averaging theorem in which an excess surface heat exchange term was introduced to control the total heat flux distribution between the solid and fluid phases within the porous region. However, either experimental studies or numerical experiments are needed to determine the excess surface heat transfer coefficient. The presented work has applications in various areas. See Narasimhan, A., and Reddy, B. V. K., 2011, “Laminar Forced Convection in a Heat Generating Bi-Disperse Porous Medium Channel,” International Journal of Heat and Mass Transfer, 54(1-3), pp. 636-644, Yang, Y. T., and Hwang, M. L., 2009, “Numerical Simulation of Turbulent Fluid Flow and Heat Transfer Characteristics in Heat Exchangers Fitted with Porous Media,” International Journal of Heat and Mass Transfer, 52(13-14), pp. 2956-2965, Yang, Y. T., and Hwang, M. L., 2008, “Numerical Simulation of Turbulent Fluid Flow and Heat Transfer Characteristics in a Rectangular Porous Channel with Periodically Spaced Heated Blocks,” Numerical Heat Transfer; Part A: Applications, 54(8), pp. 819-836, Jeng, T. M., 2008, “A Porous Model for the Square Pin-Fin Heat Sink Situated in a Rectangular Channel with Laminar Side-Bypass Flow,” hit. J. Heat Mass Transfer, 51, pp. 2214-2226, Yucel, N., and Guven, R., 2007, “Forced Convection Cooling Enhancement of Heated Elements in a Parallel Plate Channels Using Porous Inserts,” Numer, Heat Transfer, Part A, 51, pp. 293-312 and Zahmatkesh, I., and Yaghoubi, M., 2006, “Studies on Thermal Performance of Electrical Heaters by Using Porous Materials,” International Communications in Heat and Mass Transfer, 33(2), pp. 259-267.

Therefore, a need exists for revealing the phenomenon of analyzing thermal conditions at the porous-fluid interlace under LTNE conditions.

### SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for a convective heat transfer in a porous medium.

It is another aspect of the disclosed embodiments to provide for a method and system for analyzing variant thermal conditions at the porous-fluid interface under LTNE conditions.

It is a further aspect of the disclosed embodiments to provide an exact solution for restrictions on the validity of thermal conditions at a porous fluid interface.

The aforementioned aspects and other objectives and advantages can now be achieved as described herein. As indicated herein, thermal conditions at the porous-fluid interface under LTNE conditions can be analyzed. Exact solutions can be derived for both the fluid and solid temperature distributions for five of the most fundamental forms of thermal conditions at the interface between a porous medium and a fluid under LTNE conditions. The relationships between these solutions are disclosed herein.

Some embodiments herein concentrate on restrictions based on the physical attributes of the system, which must be placed for validity of the thermal interface conditions. The analytical results clearly point out the range of validity for each model. Furthermore, the range of validity of the LTE condition is disclosed herein based on the introduction of a critical parameter. The Nusselt number for the fluid at the wall of a channel that contains the fluid and porous medium can also be obtained. The effects of the pertinent parameters such as Darcy number, Biot number, Interface Biot number, and fluid to solid thermal conductivity ratio are additionally disclosed herein.

### BRIEF DESCRIPTION OF THE FIGURES

The accompanying figures, in which like reference numerals refer to identical or functionally-similar elements throughout the separate views and which are incorporated in and form a part of the specification, further illustrate the disclosed embodiments and, together with the detailed description of the disclosed embodiments, serve to explain the principles of the disclosed embodiments.

FIG. 1 illustrates a schematic diagram of a physical model and the corresponding coordinate system showing a flow through a channel filled with a porous medium, in accordance with the disclosed embodiments;

FIG. 2 illustrates a graph showing β_{cr} distributions for different parameters Bi and k, in accordance with the disclosed embodiments;

FIGS. 3A-3H illustrate graphs showing dimensionless temperature distributions for Model A for α*=0.78, Da=1×10⁻⁵, and ε=0.9, in accordance with the disclosed embodiments;

FIG. 4 illustrates a graph showing Dimensionless heat flux distributions at the interface for α*=0.78, in accordance with the disclosed embodiments;

FIGS. 5A-5D illustrate graphs showing dimensionless temperature distributions for Model C for α*=0.78, Da=1×10⁻⁵, and ε=0.9, in accordance with the disclosed embodiments;

FIGS. 6A-6B illustrate graphs showing %Δθ variations as a function of η₁ for α*=0.78 and ε=0.9, in accordance with the disclosed embodiments;

FIGS. 7A-7B illustrate graphs showing η_{1,cr} variations as a function of pertinent parameters k, Bi, Biᵢₙₜ, and Da for α*=0.78 and ε=0.9, in accordance with the disclosed embodiments;

FIGS. 8A-8B illustrate graphs showing Nusselt number variations as a function of pertinent parameters k, Bi, and Da for Model A for α*=0.78 and ε=0.9, in accordance with the disclosed embodiments;

FIG. 9 illustrates a graph showing dimensionless velocity distributions as a function of η₁ for α*=0.78, in accordance with the disclosed embodiments;

FIG. 10 illustrates a graph showing the variation of the maximum velocity at the open region for pertinent parameters η₁ and Da for α*=0.78, in accordance with the disclosed embodiments;

FIGS. 11A-11B illustrate graphs showing Nusselt number variations as a function of pertinent parameters k, Bi, and β for Model B for α*=0.78 and ε=0.9, in accordance with the disclosed embodiments; and

FIGS. 12A-12D illustrate graphs showing Nusselt number variations as a function of pertinent parameters k, Bi, and Biᵢₙₜ for Model C for α*=0.78 and ε=0.9, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The following Table 1 provides the various symbols and meanings used in this section:

TABLE 1

| | |
|---|---|
| Bi | $Bi = \frac{{h}_{i} {αH}^{2}}{{k}_{s , eff}} , Biot number defined by equation ( 22 )$ |
| Biᵢₙₜ | ${Bi}_{int} = \frac{{h}_{int} H}{{k}_{s , eff}} , interface Biot number defined by equation ( 22 )$ |
| cₚ | specific heat of the fluid [J kg⁻¹ K⁻¹] D₀, D₁, D₂, D₃, D₄, D₅, D₆, |
| | D₇, D₈, D₉, parameters calculated by equations (45), (57) and (74) |
| Da | $Da = \frac{K}{{H}^{2}} , Darcy number$ |
| hᵢ | interstitial heat transfer coefficient [W m⁻² K⁻¹] |
| hᵢₙₜ | interface heat transfer coefficient [W m⁻² K⁻¹] |
| h_{w} | wall heat transfer coefficient defined by equation (68) |
| | [W m⁻² K⁻¹] |
| H | half height of the channel [m] |
| H₁ | half height of the porous media [m] |
| k | $\begin{matrix}k = \frac{{k}_{f , eff}}{{k}_{s , eff}} , ratio of the fluid effective thermal conductivity to \\ that of the solid permeability [ {m}^{2} ]\end{matrix}$ |
| K | permeability [m²] |
| k₁ | $\begin{matrix}{k}_{1} = \frac{{k}_{f}}{{k}_{s , eff}} , ratio of the fluid thermal conductivity to the \\ solid effective thermal conductivity\end{matrix}$ |
| k_{f} | thermal conductivity of the fluid [W m⁻¹ K⁻¹] |
| k_{f,eff} | effective thermal conductivity of the fluid [W m⁻¹ K⁻¹] |
| kₛ | thermal conductivity of the solid [W m⁻¹ K⁻¹] |
| k_{s,eff} | effective theraml conductivity of the solid [W m⁻¹ K⁻¹] |
| Nu | Nusselt number |
| p | pressure [N m⁻²] |
| qᵢ | heat flux at the interface [W m⁻²] |
| q_{w} | heat flux at the wall [W m⁻²] |
| T | temperature [K] |
| u | fluid velocity [m s⁻¹] |
| uₘ | area average velocity over the channel cross section [m s⁻¹] |
| U | $U = \frac{u}{- \frac{{H}^{2}}{{μ}_{f}} \frac{dp}{dx}} , dimensionless fluid velocity$ |
| U_{B} | dimensionless interface velocity |
| Uₘ | dimensionless average velocity over the channel cross section |
| x | longitudinal coordinate [m] |
| y | transverse coordinate [m] |

Greek symbols

| | |
|---|---|
| α | interfacial area per unit volume of the porous medium [m⁻¹] |
| α* | velocity slip coefficient at the interface |
| ε | porosity |
| β | ratio of heat flux for the fluid phase to the total heat flux at the |
| | interface |
| β₁, β₂, | ratio of heat flux for the fluid phase to the total heat flux at the |
| β₃ | interface defined by equation (17) |
| η | $η = \frac{y}{H} , non \text{-} dimensional transverse coordinate$ |
| η₁ | ${η}_{1} = \frac{{H}_{1}}{H} , non \text{-} dimensional half height of the porous media$ |
| θ | $\begin{matrix}θ = \frac{{k}_{s , eff} ( T - {T}_{s , i} )}{{q}_{w} H} , non \text{-} dimensional temperature , defined by \\ equation ( 22 )\end{matrix}$ |
| μ | dynamic viscosity [kg m⁻¹ s⁻¹] |
| ρ | density [kg m⁻³] |
| γ | $γ = \frac{{q}_{i}}{{q}_{w}} , dimensionless heat flux at the interface$ |
| λ | λ = \sqrt{Bi(1 + k)/k}, parameter calculated by equation (43) |
| ρ | fluid density [kg m⁻³] |

Subscripts

| | |
|---|---|
| b | bulk mean value |
| cr | critical value |
| f | fluid |
| l | interface |
| open | open region |
| p | porous region |
| s | solid phase |
| w | wall |

The disclosed embodiments can be implemented to analyze five of the most fundamental forms of thermal conditions at the interface between a porous medium and a fluid under LTNE condition leading to a presentation of exact solutions for all of the analyzed conditions. The work concentrates on the restrictions based on the physical attributes of the system that must be placed for the validity of the thermal interface conditions. The analytical results clearly point out the range of validity for each model in terms of the pertinent physical parameters. This is the first time that the existence of restrictions on the validity of the thermal conditions at the porous-fluid interface has been established. This is crucial as the inappropriate use of the interface conditions can lead to substantial errors. Furthermore, the range of validity of the LTE condition is discussed based on the introduction of a critical parameter.

### 1. MODELING AND FORMULATION

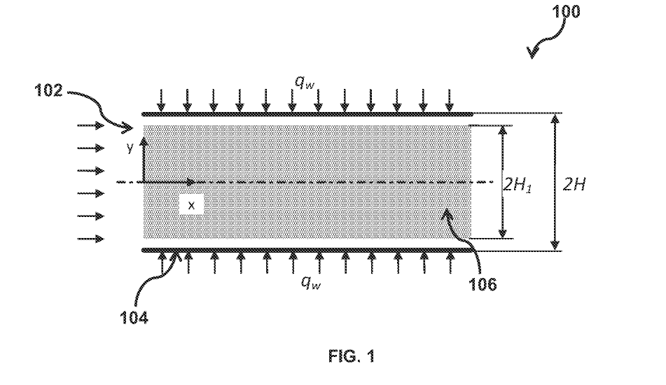

FIG. 1 illustrates a schematic diagram of a physical model and the corresponding coordinate system 100. Fluid 102 flows through a rectangular channel 104 partially filled with a porous medium 106 subject to a constant heat flux boundary condition. The height of the channel 104 is 2H, the height of the porous medium 106 is 2H₁, and the heat flux applied at the wall is q_{w}. The following assumptions are invoked in the analyzing this problem. The flow is steady and incompressible, natural convection and radiative heat transfer are negligible, fully developed heat and flow fields are considered and fluid flow through the porous medium is represented by the Darcian flow model and properties such as porosity, specific heat, density and thermal conductivity are assumed to be constant.

Based on these assumptions, the governing conservation equations are written separately for the porous and open regions. For the porous region, the energy equations are obtained from the works of Amiri and Vafai employing the local thermal non-equilibrium model. See Amiri, A., and Vafai, K., 1994, “Analysis of Dispersion Effects and Non-Thermal Equilibrium Non-Darcian, Variable Porosity Incompressible Flow through Porous Medium,” International Journal of Heat and Mass Transfer, 37, pp. 939-954 and Amiri, A., and Vafai, K., 1998, “Transient Analysis of Incompressible Flow Through A Packed Bed,” hit. J. Heat Mass Transfer, 41, pp. 4259-4279.

$$\begin{matrix}Fluid phase \\ {k}_{f , eff} \frac{{\partial }^{2} {T}_{f}}{\partial {y}^{2}} + {h}_{i} α ( {T}_{s} - {T}_{f} ) = ρ {c}_{p} u \frac{\partial {T}_{f}}{\partial x} & Eq . ( 1 ) \\ Solid phase \\ {k}_{s , eff} \frac{{\partial }^{2} {T}_{s}}{\partial {y}^{2}} - {h}_{i} α ( {T}_{s} - {T}_{f} ) = 0 & Eq . ( 2 )\end{matrix}$$

wherein T_{f} and Tₛ are the fluid and solid temperatures, u the fluid velocity, k_{f,eff} and k_{s,eff} the effective fluid and solid thermal conductivities, respectively, ρ and cₚ the density and specific heat of the fluid, hᵢ the interstitial heat transfer coefficient, and α is the interfacial area per unit volume of the porous medium.

The momentum equation in the porous region is

$$- \frac{{μ}_{f}}{K} u - \frac{d p}{d x} = 0 \qquad Eq . ( 3 )$$

wherein K denotes the permeability, μ_{f} the fluid dynamic viscosity, and p the pressure.

For the open region the momentum and energy equations, respectively, are

$$\begin{matrix}- \frac{d p}{d x} + {μ}_{f} \frac{{d}^{2} u}{d {y}^{2}} = 0 & Eq . ( 4 ) \\ {k}_{f} \frac{{\partial }^{2} {T}_{f}}{\partial {y}^{2}} = ρ {c}_{p} u \frac{\partial {T}_{f}}{\partial x} & Eq . ( 5 )\end{matrix}$$

The boundary conditions for this problem are

$$\begin{matrix}\frac{\partial u}{\partial y} {\vert}_{y = 0} = 0 & Eq . ( 6 ) \\ \frac{\partial {T}_{f}}{\partial y} {\vert}_{y = 0} = \frac{\partial {T}_{s}}{\partial y} {\vert}_{y = 0} = 0 & Eq . ( 7 ) \\ u {\vert}_{y = H} = 0 & Eq . ( 8 ) \\ {k}_{f} \frac{\partial {T}_{f}}{\partial y} {\vert}_{y = H} = {q}_{w} & Eq . ( 9 ) \\ \frac{\partial u}{\partial y} {\vert}_{y = {H}_{1}^{+}} = \frac{{α}^{*}}{\sqrt{K}} ( {u}_{B} - {u}_{p} ) & Eq . ( 10 )\end{matrix}$$

which is the slip velocity condition at the interface between the open and porous regions based on Beavers, G. S., and Joseph, D. D., 1967, “Boundary Conditions at A Naturally Permeable Wall,” J. Fluid Mech., 30(1), pp. 197-207, where u_{B} denotes the interface velocity, uₚ the velocity in the porous medium, α* the velocity slip coefficient, which is a dimensionless quantity depending on the material.

Five models can be developed to describe the temperature interface conditions between the open and porous regions. These are models A, B (composed of three sub models: B.1, B.2 & B.3) and model C. The interface conditions for these models are given below:

### 1.1 Model A

When the heat transfer between the fluid and solid phases at the interface is large enough, their temperatures are equal at the interface. That is

$$\begin{matrix}{T}_{f} {\vert}_{y = {H}_{1}^{-}} = {T}_{s} {\vert}_{y = {H}_{1}^{-}} = {T}_{f} {\vert}_{y = {H}_{1}^{+}} & Eq . ( 11 ) \\ {k}_{f , eff} \frac{\partial {T}_{f}}{\partial y} {\vert}_{y = {H}_{1}^{-}} + {k}_{s , eff} \frac{\partial {T}_{s}}{\partial y} {\vert}_{y = {H}_{1}^{-}} = {k}_{f} \frac{\partial {T}_{f}}{\partial y} {\vert}_{y = {H}_{1}^{+}} = {q}_{i} & Eq . ( 12 )\end{matrix}$$

wherein q₁ is the heat flux at the interface, which represents the heat energy transferred through the porous region.

### 1.2 Model B

For most cases, the heat transfer between the fluid and solid phases at the interface is not large enough, thus their temperatures are not equal at the interface. Therefore, an interface thermal parameter, β, is introduced to evaluate the total heat flux distribution between the solid and fluid phases at the interface in Model B.

$$\begin{matrix}{T}_{f} {\vert}_{y = {H}_{1}^{-}} = {T}_{f} {\vert}_{y = {H}_{1}^{+}} & Eq . ( 13 ) \\ {k}_{f} \frac{\partial {T}_{f}}{\partial y} {\vert}_{y = {H}_{1}^{+}} = {q}_{i} & Eq . ( 14 ) \\ {k}_{f , eff} \frac{\partial {T}_{f}}{\partial y} {\vert}_{y = {H}_{1}^{-}} β {q}_{i} & Eq . ( 15 ) \\ {k}_{s , eff} \frac{\partial {T}_{s}}{\partial y} {\vert}_{y = {H}_{1}^{-}} = ( 1 - β ) {q}_{i} & Eq . ( 16 )\end{matrix}$$

wherein β is the ratio of heat flux for the fluid phase to the total heat flux at the interface. The ratio β can be calculated based on the following three different methods.

$$\begin{matrix}Model B .1 & \\ {β}_{1} = \frac{{k}_{f , eff}}{{k}_{f , eff} + {k}_{s , eff}} & Eq . ( 17.1 ) \\ Model B .2 & \\ {β}_{2} = \frac{{k}_{f}}{{k}_{f} + {k}_{s}} & Eq . ( 17.2 ) \\ Model B .3 & \\ {β}_{3} = ɛ & Eq . ( 17.3 )\end{matrix}$$

wherein ε denotes porosity, k_{f} and kₛ the fluid and solid thermal conductivities, respectively.

### 1.3 Model C

The temperatures of fluid and solid phases are considered not to be equal at the interface, and the heat flux jump interfacial condition presented by Ochoa-Tapia, J. A., and Whitaker, S., 1997, “Heat transfer at the boundary between a porous medium and a homogeneous fluid,” Int. J. Heat Mass Transfer, 40(11), pp. 2691-2707 is utilized as the basis for Model C, in which a interface heat transfer coefficient, hᵢₙₜ, is introduced to calculate the heat exchange between fluid and solid phases at the interface.

$$\begin{matrix}{T}_{f} {\vert}_{y = {H}_{1}^{-}} = {T}_{f} {\vert}_{y = {H}_{1}^{+}} & Eq . ( 18 ) \\ {k}_{f} \frac{\partial {T}_{f}}{\partial y} {\vert}_{y = {H}_{1}^{+}} = {q}_{i} & Eq . ( 19 ) \\ {k}_{f , eff} \frac{\partial {T}_{f}}{\partial y} {\vert}_{y = {H}_{1}^{-}} = {q}_{i} - {h}_{int} ( {T}_{f} {\vert}_{y = {H}_{1}^{-}} - {T}_{s} {\vert}_{y = {H}_{1}^{-}} ) & Eq . ( 20 ) \\ {k}_{s , eff} \frac{\partial {T}_{s}}{\partial y} {\vert}_{y = {H}_{1}^{-}} = {h}_{int} ( {T}_{f} {\vert}_{y = {H}_{1}^{-}} - {T}_{s} {\vert}_{y = {H}_{1}^{-}} ) & Eq . ( 21 )\end{matrix}$$

To normalize the governing equations, boundary conditions, and interface conditions, the following dimensionless variables are introduced:

$$\begin{matrix}θ = \frac{{k}_{s , eff} ( T - {T}_{s , i} )}{{q}_{w} H} & Eq . ( 22 a ) \\ η = \frac{y}{H} & Eq . ( 22 b ) \\ {η}_{1} = \frac{{H}_{1}}{H} & Eq . ( 22 c ) \\ k = \frac{{k}_{f , eff}}{{k}_{s , eff}} & Eq . ( 22 d ) \\ {k}_{1} = \frac{{k}_{f}}{{k}_{s , eff}} & Eq . ( 22 e ) \\ Bi = \frac{{h}_{i} α {H}^{2}}{{k}_{s , eff}} & Eq . ( 22 f ) \\ {Bi}_{int} = \frac{{h}_{int} H}{{k}_{s , eff}} & Eq . ( 22 g ) \\ Da = \frac{K}{{H}^{2}} & Eq . ( 22 h ) \\ U = \frac{u}{- \frac{{H}^{2}}{{μ}_{f}} \frac{d p}{d x}} & Eq . ( 22 i ) \\ γ = \frac{{q}_{i}}{{q}_{w}} & Eq . ( 22 j )\end{matrix}$$

wherein T_{s,i} is the temperature for solid phase at the interface, Bi is the Biot number which represents the ratio of the conduction resistance of the solid phase to the heat exchange resistance between the fluid and solid phases. See Marafie, A., and Vafai, K., 2001, “Analysis of Non-Darcian effects on Temperature Differentials in Porous Media,” International Journal of Heat and Mass Transfer, 44, pp. 4401-4411.

Adding governing equations (1) and (2) and integrating the resultant equation from the center to the fluid-porous interface and applying the corresponding boundary and interface conditions, the following equation can be obtained:

$$ρ {c}_{p} {u}_{p} \frac{\partial {T}_{f}}{\partial x} = \frac{{q}_{i}}{{H}_{1}} \qquad Eq . ( 23 )$$

By integrating equation (5) from the interface to the wall and applying the corresponding boundary and interface conditions, the following equation can be obtained:

$$ρ {c}_{p} {u}_{m , open} \frac{\partial {T}_{f}}{\partial x} = \frac{{q}_{w} - {q}_{i}}{H - {H}_{1}} \qquad Eq . ( 24 )$$

wherein u_{m,open} is the average fluid velocity within the open region.

Based on the work of Beavers, G. S., and Joseph, D. D., 1967, “Boundary Conditions at A Naturally Permeable Wall,” J. Fluid Mech., 30(1), pp. 197-207, the solutions for momentum equations (3) and (4) and the corresponding boundary and interface conditions (6), (8), and (10) are obtained as:

For the porous region:

U=Da 0≦η≦η₁ Eq. (25)

For the open region:

$$U = - 0.5 {( η - {η}_{1} )}^{2} + \frac{{α}^{*}}{\sqrt{Da}} ( {U}_{B} - {D}_{a} ) ( η - {η}_{1} ) + {U}_{B} \\ {η}_{1} < η \leq 1 \qquad Eq . ( 26 )$$

wherein U_{B} is the dimensionless interface velocity

$${U}_{B} = \frac{0.5 {( 1 - {η}_{1} )}^{2} + {α}^{*} \sqrt{Da} ( 1 - {η}_{1} )}{1 + \frac{{α}^{*}}{\sqrt{Da}} ( 1 - {η}_{1} )} \qquad Eq . ( 27 )$$

The dimensionless average velocity within the open region is calculated as:

$${U}_{m , open} = - \frac{1}{6} {( 1 - {η}_{1} )}^{2} + \frac{{α}^{*}}{2 \sqrt{Da}} ( {U}_{B} - Da ) ( 1 - {η}_{1} ) + {U}_{B} \qquad Eq . ( 28 )$$

The dimensionless average velocity over the channel cross section is calculated as:

Uₘ=η₁Da+(1−η₁)U_{m,open} Eq. (29)

Based on equations (22-25), (28), and (29), the dimensionless heat flux at the interface is derived as:

$$γ = \frac{{q}_{i}}{{q}_{w}} = \frac{{η}_{1} Da}{{U}_{m}} \qquad Eq . ( 30 )$$

### 1.4. Temperature Solution for Interface Condition of Model A

Using equations (22)-(30), the energy equations and the corresponding boundary and interface conditions for Model A can be rewritten as:

$$\begin{matrix}k \frac{{\partial }^{2} {θ}_{f}}{\partial {η}^{2}} + Bi ( {θ}_{x} - {θ}_{f} ) = \frac{γ}{{η}_{1}} 0 \leq η \leq {η}_{1} & Eq . ( 31 ) \\ \frac{{\partial }^{2} {θ}_{s}}{\partial {η}^{2}} - Bi ( {θ}_{s} - {θ}_{f} ) = 0 \; 0 \leq η \leq {η}_{1} & Eq . ( 32 ) \\ {k}_{1} \frac{{\partial }^{2} {θ}_{f}}{\partial {η}^{2}} = \frac{U}{{U}_{m}} {η}_{1} < η \leq 1 & Eq . ( 33 ) \\ \frac{\partial {θ}_{f}}{\partial η} {\vert}_{η = 0} = \frac{\partial {θ}_{s}}{\partial η} {\vert}_{η = 0} = 0 & Eq . ( 34 ) \\ {θ}_{f} {\vert}_{η = {η}_{1}^{-}} = {θ}_{s} {\vert}_{η = {η}_{1}^{-}} = {θ}_{f} {\vert}_{η = {η}_{1}^{+}} = 0 & Eq . ( 35 ) \\ \frac{\partial {θ}_{f}}{\partial η} {\vert}_{η = 1} = \frac{1}{{k}_{1}} & Eq . ( 36 )\end{matrix}$$

Utilizing the two coupled governing equations (31) and (32), the following governing equations for the fluid and solid temperatures of porous region are obtained:

$$\begin{matrix}k {θ}_{f}^{″} - ( 1 + k ) Bi {θ}_{f}^{′} = - Bi \frac{γ}{{η}_{1}} & Eq . ( 37 ) \\ k {θ}_{s}^{″} - ( 1 + k ) Bi {θ}_{s}^{′} = - Bi \frac{γ}{{η}_{1}} & Eq . ( 38 )\end{matrix}$$

By utilizing the boundary and interface conditions (34) and (35) in equations (31) and (32), the following equations are obtained:

$$\begin{matrix}{θ}_{f}^{′} ( {η}_{1}^{-} ) = \frac{γ}{{η}_{1} k} {θ}_{s}^{′} ( {η}_{1}^{-} ) = 0 & Eq . ( 39 ) \\ {θ}_{f}^{′} ( 0 ) = {θ}_{s}^{″} ( 0 ) = 0 & Eq . ( 40 )\end{matrix}$$

The temperature distribution for porous region is found by solving equations (37) and (38) and applying the boundary equations (34), (35), (39), and (40). The resultant equations are:

$$\begin{matrix}{θ}_{f} = \frac{γ}{( 1 + k ) {η}_{1}} \{ \frac{1}{2} ( {η}^{2} - {η}_{1}^{2} ) + \frac{1}{( 1 + k ) Bi} [ \frac{cosh ( λ η )}{cosh ( λ {η}_{1} )} - 1 ] \} & Eq . ( 41 ) \\ {θ}_{s} = \frac{γ}{( 1 + k ) {η}_{1}} \{ \frac{1}{2} ( {η}^{2} - {η}_{1}^{2} ) + \frac{1}{( 1 + k ) Bi} [ 1 - \frac{cosh ( λ η )}{cosh ( λ {η}_{1} )} ] \} & Eq . ( 42 ) \\ where λ = \sqrt{Bi ( 1 + k ) / k} & Eq . ( 43 )\end{matrix}$$

The temperature distribution for open region is found by solving equation (33) and applying the boundary equations (35) and (36). The resultant equations are

$$\begin{matrix}{θ}_{f} = {{D}_{0} ( η - {η}_{1} )}^{4} + {{D}_{1} ( η - {η}_{1} )}^{3} + {{D}_{2} ( η - {η}_{1} )}^{2} + {D}_{3} ( η - {η}_{1} ) & Eq . ( 44 ) \\ where {D}_{0} = - \frac{1}{24 {U}_{m} {k}_{1}} \\ {D}_{1} = \frac{{α}^{*}}{6 {U}_{m} {k}_{1} \sqrt{Da}} ( {U}_{B} - Da ) \\ {D}_{2} = \frac{{U}_{B}}{2 {U}_{m} {k}_{1}} \\ {D}_{3} = \frac{1}{{k}_{1}} - 4 {{D}_{0} ( 1 - {η}_{1} )}^{3} - 3 {{D}_{1} ( 1 - {η}_{1} )}^{2} - 2 {D}_{2} ( 1 - {η}_{1} ) & Eq . ( 45 )\end{matrix}$$

### 1.5. Temperature Solution for Interface Condition of Model B

The interface conditions for Model B can be rewritten as:

$$\begin{matrix}{θ}_{s} {\vert}_{η = {η}_{1}^{-}} = 0 & Eq . ( 46 ) \\ \frac{\partial {θ}_{f}}{\partial η} {\vert}_{η = {η}_{1}^{-}} = \frac{βγ}{k} & Eq . ( 47 ) \\ {θ}_{f} {\vert}_{η = {η}_{1}^{-}} = {θ}_{f} {\vert}_{η = {η}_{1}^{+}} & Eq . ( 48 )\end{matrix}$$

The temperature distribution is found by solving governing equations (31), (32), and (33) and applying the boundary and interface condition equations (34), (36), (46), (47), and (48). This results in:

$$\begin{matrix} For porous region & \\ {θ}_{f} = \frac{γ}{( 1 + k ) λ sinh ( λ {η}_{1} )} [ β - k ( 1 - β ) ] [ \frac{cosh ( λ η )}{k} + cosh ( λ {η}_{1} ) ] + \frac{γ ( {η}^{2} - {η}_{1}^{2} )}{2 {η}_{1} ( 1 + k )} - \frac{γ}{( 1 + k ) {η}_{1} Bi} & Eq . ( 49 ) \\ {θ}_{s} = \frac{γ}{( 1 + k ) λ sinh ( λ {η}_{1} )} [ β - k ( 1 - β ) ] [ cosh ( λ {η}_{1} ) - cosh ( λ η ) ] + \frac{γ ( {η}^{2} - {η}_{1}^{2} )}{2 {η}_{1} ( 1 + k )} & Eq . ( 50 ) \\ For open region & \\ {θ}_{f} = {{D}_{0} ( η - {η}_{1} )}^{4} + {{D}_{1} ( η - {η}_{1} )}^{3} + {{D}_{2} ( η - {η}_{1} )}^{2} + {D}_{3} ( η - {η}_{1} ) + {θ}_{f} ( {η}_{1}^{-} ) & Eq . ( 51 )\end{matrix}$$

where θ_{f}(η₁⁻) be calculated using equation (49), D₀, D₁, D₂, and D₃ can be calculated using equation (45).

### 1.6. Temperature Solution for Interface Condition of Model C

The interface conditions for Model C can be rewritten as

$$\begin{matrix}{θ}_{s} {\vert}_{η = {η}_{1}^{-}} = 0 & Eq . ( 52 ) \\ k \frac{\partial {θ}_{f}}{\partial η} {\vert}_{η = {η}_{1}^{-}} = γ - {Bi}_{int} ( {θ}_{f} {\vert}_{η = {η}_{1}^{-}} - {θ}_{s} {\vert}_{η = {η}_{1}^{-}} ) & Eq . ( 53 ) \\ {θ}_{f} {\vert}_{η = {η}_{1}^{-}} = {θ}_{f} {\vert}_{η = {η}_{1}^{+}} & Eq . ( 54 )\end{matrix}$$

The temperature distribution is found by solving governing equations (31), (32), and (33) and applying the boundary and interface condition equations (34), (36), (52), (53), and (54). This results in:

$$\begin{matrix} For porous region & \\ {θ}_{f} = \frac{γ {D}_{4}}{{λ}^{2} {η}_{1}} cosh ( λ η ) + \frac{{γη}^{2}}{2 {η}_{1} ( 1 + k )} + {γη}_{1} {D}_{5} & Eq . ( 55 ) \\ {θ}_{s} = \frac{γ {D}_{6}}{{λ}^{2} {η}_{1}} cosh ( λ η ) + \frac{{γη}^{2}}{2 {η}_{1} ( 1 + k )} + {γη}_{1} {D}_{7} & Eq . ( 56 ) \\ where & \\ {D}_{4} = \frac{B i {η}_{1} + {Bi}_{int}}{λ {k}^{2} sinh ( λ {η}_{1} ) + B {i}_{int} k ( 1 + k ) cosh ( λ {η}_{1} )} \\ {D}_{5} = \frac{{D}_{4} {k}^{2}}{B i {η}_{1}^{2} ( 1 + k )} cosh ( λ {η}_{1} ) - \frac{1}{B i {η}_{1}^{2} ( 1 + k )} - \frac{1}{2 ( 1 + k )} \\ {D}_{6} = \frac{{D}_{8} {Bi}_{int} {η}_{1} ( 1 + k ) - 1}{sinh ( λ {η}_{1} ) ( 1 + k )} λ {η}_{1} \\ {D}_{7} = \frac{{D}_{6}}{{λ}^{2} {η}_{1}^{2}} cosh ( λ {η}_{1} ) - \frac{1}{2 ( 1 + k )} \\ {D}_{8} = \frac{{D}_{4}}{{λ}^{2} {η}_{1}^{2}} cosh ( λ {η}_{1} ) + \frac{1}{2 ( 1 + k )} + {D}_{5} & Eq . ( 57 ) \\ For open region & \\ {θ}_{f} = {{D}_{0} ( η - {η}_{1} )}^{4} + {{D}_{1} ( η - {η}_{1} )}^{3} + {{D}_{2} ( η - {η}_{1} )}^{2} + {D}_{3} ( η - {η}_{1} ) + {θ}_{f} ( {η}_{1}^{-} ) & Eq . ( 58 )\end{matrix}$$

where θ_{f} (η₁⁻) can be calculated using equation (55), D₀, D₁, D₂, and D₃ can be calculated using equation (45).

### 2. RESULTS AND DISCUSSION

### 2.1. Validity of the Interface Thermal Models

In order to satisfy the second law of thermodynamics, the dimensionless fluid phase temperature at the interface should be larger than the dimensionless solid phase temperature at the interface, that is:

θ_{f}|_{η=η}_{₁}_{^{−}}≧θₛ|_{η=η}_{₁}_{^{−}} Eq. (59)

Substituting equations (49) and (50) in equation (59), results in:

1≧β≧β_{cr} Eq. (60)

wherein β_{cr} denotes critical ratio of heat flux for the fluid phase to the total heat flux at the interface, which represents the minimum ratio of heat flux for the fluid phase to the total heat flux at the interface.

$${β}_{cr} = \frac{\frac{sinh ( λ {η}_{1} )}{λ {η}_{1} cosh ( λ {η}_{1} )} + k}{1 + k} \qquad Eq . ( 61 )$$

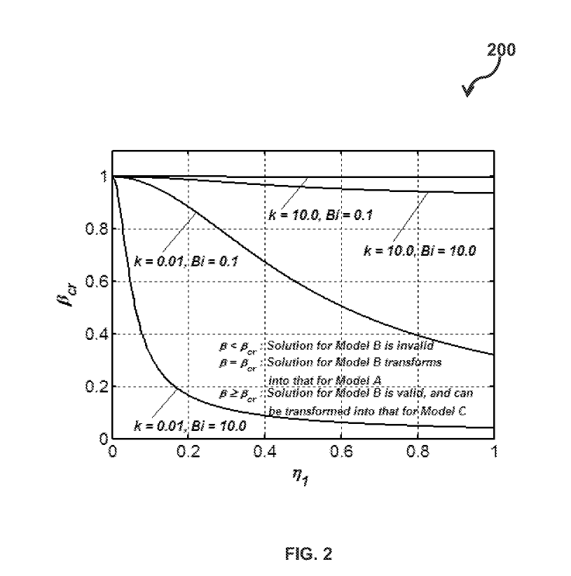

Critical heat flux ratio β_{cr} distributions for different parameters Bi and k are shown in FIG. 2. It is found that β_{cr} increases as η₁ and Bi become smaller or k becomes larger. When Bi=0.1 and k=10, β_{cr} is very close to 1, which means most of the heat flux at the interface is transferred through the fluid phase of the porous medium. When η₁ approaches zero, β_{cr} approaches 1, and again most of the heat flux at the interface is transferred through the fluid phase. Utilizing condition (60), the validity of equation (17) can be assessed.

(a) It should be noted that β_{cr}≧β₁, and only when λ approaches infinity, β_{cr} approaches β₁. Based on condition (60) and equation (43), this means that the β₁ is valid when Bi approaches infinity.

(b) The effective thermal conductivity of the fluid and solid phases of porous media can be represented by:

k_{f,eff}=□k_{f} Eq. (62)

k_{s,eff}=(1□□)kₛ Eq. (63)

Substituting equations (62) and (63) in equation (17.2), which uses only k_{f} and kₛ, and not k_{f,eff} and k_{s,eff}, results in:

$${β}_{2} = \frac{k}{k + \frac{ɛ}{1 - ɛ}} \qquad Eq . ( 64 )$$

when ε>0.5, β₂<β_{cr}. This means that β₂ is not valid for ε>0.5. (c)β₃ is valid for ε≧β_{cr}.

### 2.2. Equivalence Correlations Between Different Interface Thermal Models

Comparison of the solutions for Model A, Model B, and Model C reveals some interesting physical features. It is found that these solutions can be transformed between each other as described below.

(a) When β=β_{cr}, the temperatures of fluid and solid phases at the interface will be equal, thus the solution for Model B will transform into the solution for Model A.

(b) When β=1−D₈Biᵢₙₜη₁, the solution for Model B will transform into the solution for Model C.

(c) When Biᵢₙₜ→∞, the temperatures of fluid and solid phases at the interface will be equal, thus the solution for Model C will transform into the solution for Model A, and the solid phase at the interface will get the maximum fraction of the total heat flux at the interface, which is equal to 1−β_{cr}.

(d) When Biᵢₙₜ→0, the heat exchange between fluid and solid phases at the interface vanish, thus the solution for Model C will transform into the solution for Model B for β=1.

### 3.3. Temperature Results and the Validity of the LTE Condition

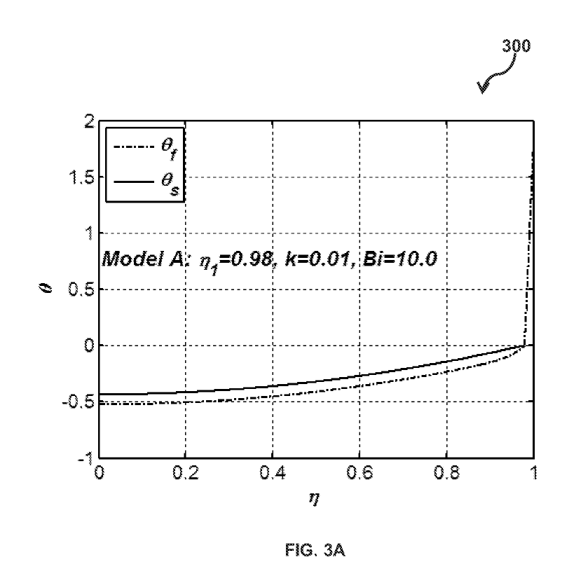

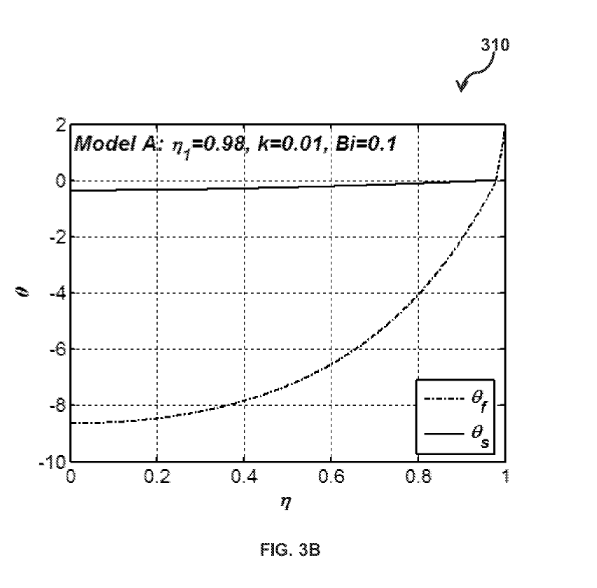

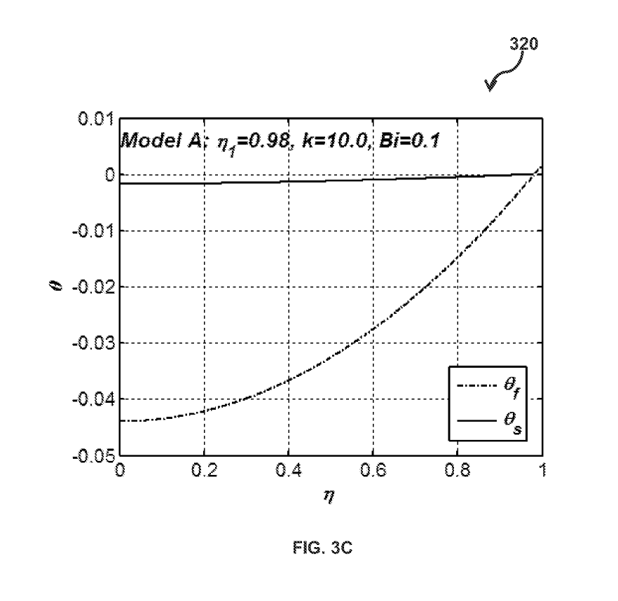

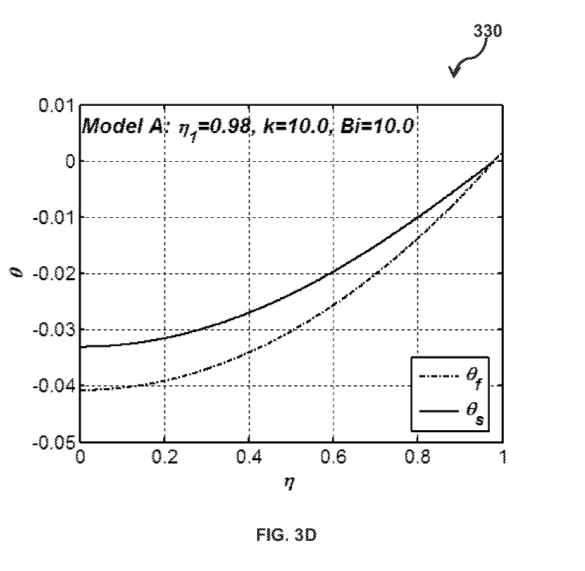

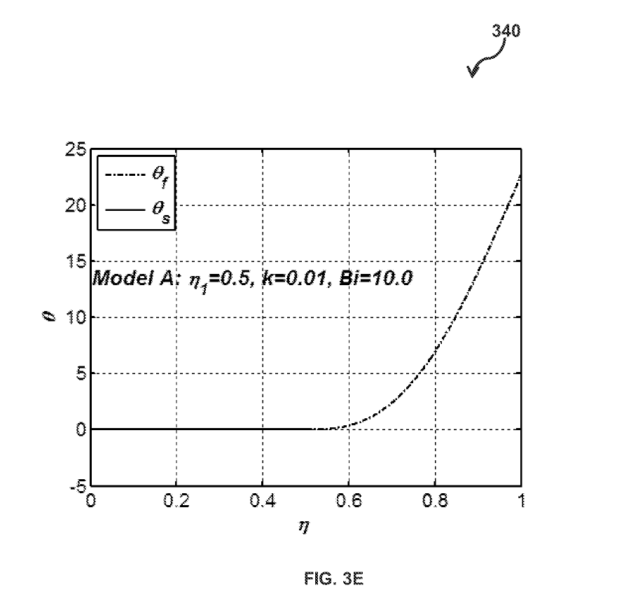

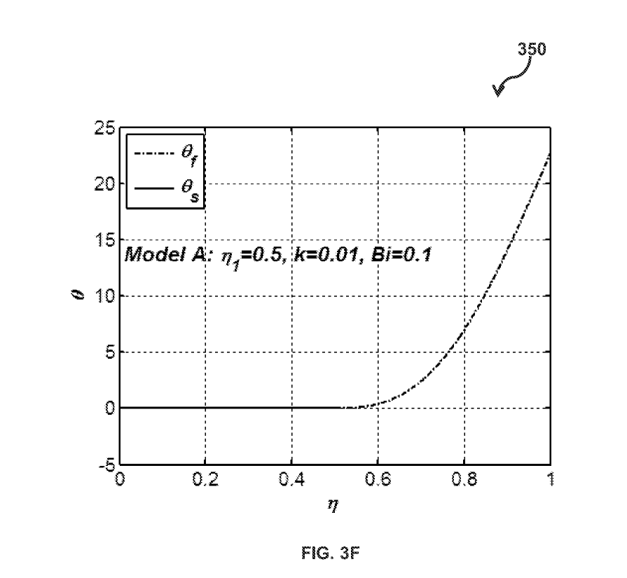

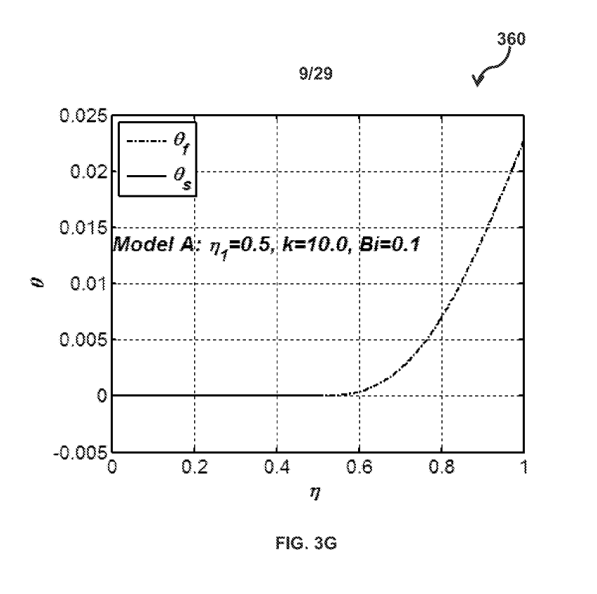

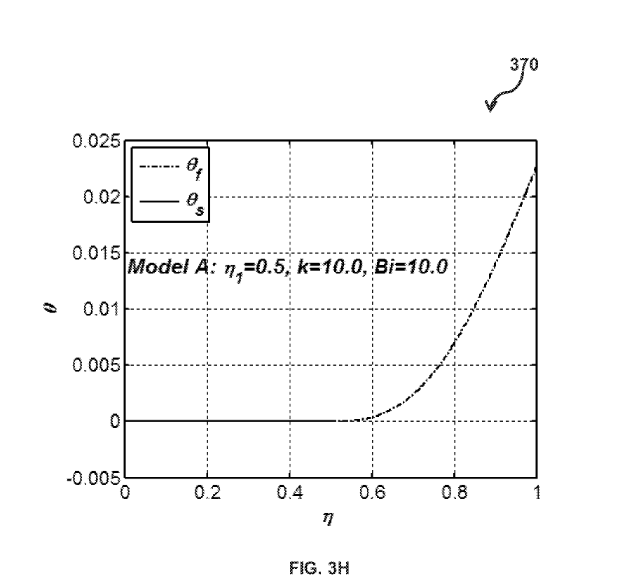

The dimensionless temperature distributions for Model A for different pertinent parameters η₁, Bi, and k are shown in FIGS. 3A-3H as graphs 300, 310, 320, 330, 340, 350, 360, and 370. It should be noted that based on the above-mentioned discussion, these temperatures are also the solutions for Model B for β=β_{cr} and the solutions for model C for Biᵢₙₜ→∞. When Bi is small, which translates into a weak internal heat transfer between the fluid and solid phases, the temperature difference between the two phases is relatively large, as shown in FIGS. 3B-3C. However, when η₁ decreases, the temperature difference between the two phases is quite small, even for a small Bi, as shown in FIGS. 3E-3F.

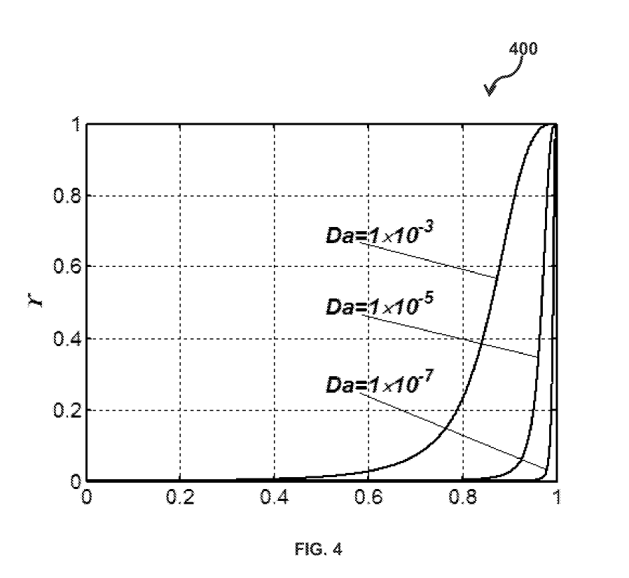

FIG. 4 illustrates graph 400 showing Dimensionless heat flux distributions at the interface for α*=0.78, in accordance with the disclosed embodiments. The reason for this phenomenon is that when η₁ is small, the heat flux at the interface is also small, as shown in FIG. 4. This means that only a small proportion of the imposed heat flux at the boundary is transferred into porous region, thus the influences of Bi and k can be negligible. From equation (30), it is found that the heat flux distributions at the interface are mainly dependent on Da and η₁, and independent of Bi and k.

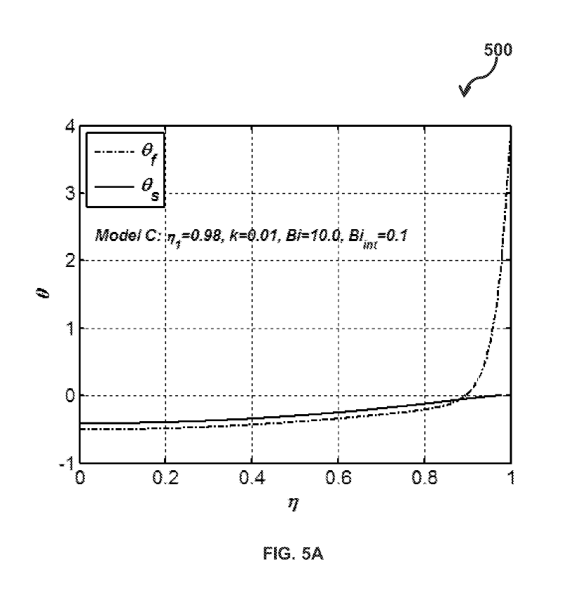

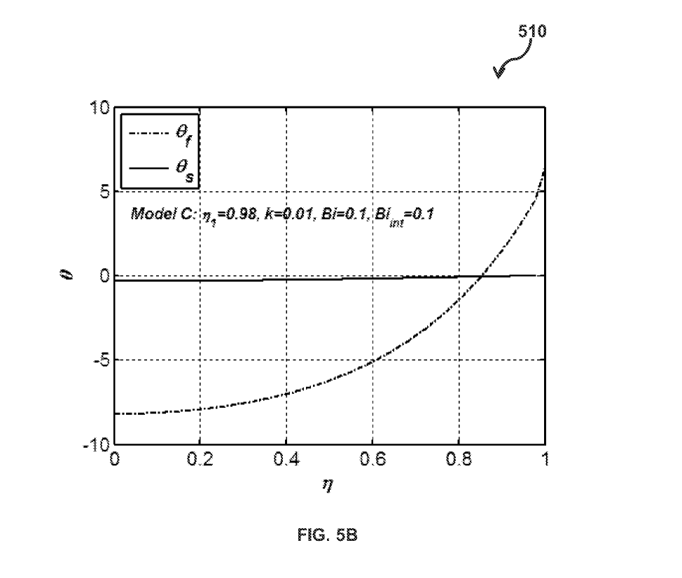

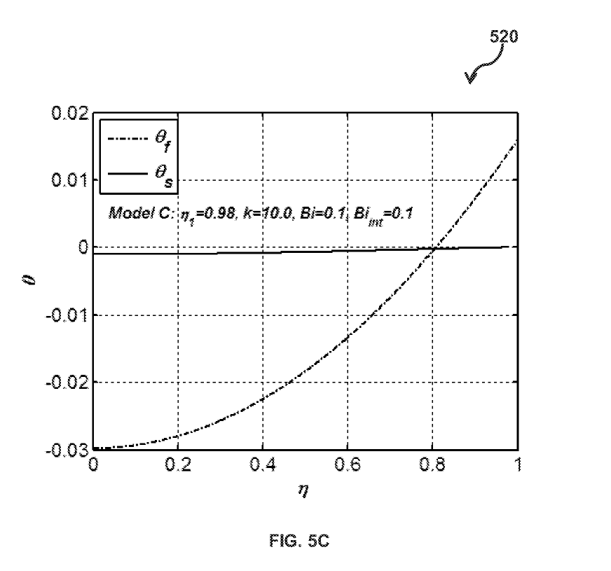

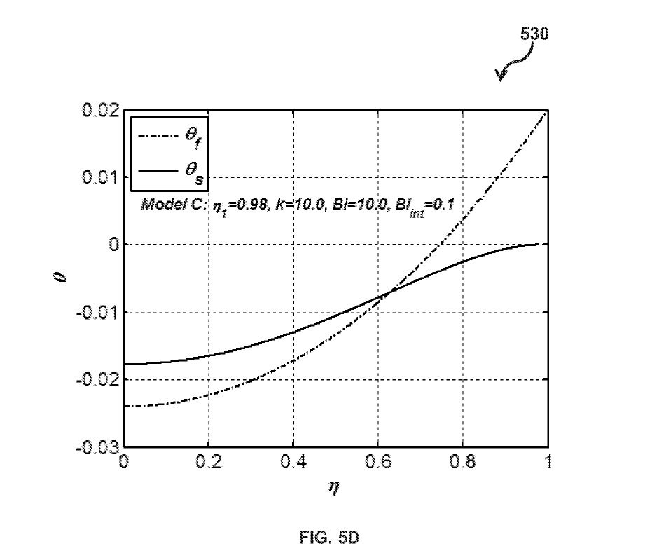

As can be seen in FIG. 4, when Da increases, more energy will be transferred through the porous region, thus the properties of the porous medium will have more influence on the temperature distributions. The dimensionless temperature distributions for Model C are shown in FIGS. 5A-5D as graphs 500, 510, 520, and 530. Comparing FIGS. 3A-3D and 5, it is found the temperature difference between fluid and solid phases at the interface increases as Biᵢₙₜ becomes smaller. Different Biᵢₙₜ will result different temperature distributions within the porous region. When Biᵢₙₜ→∞, the solid phase temperature is always larger than that of the fluid phase within the porous region except the porous-fluid interface, where the temperature of solid phase is equal to that of the fluid phase. However, when Biᵢₙₜ doesn't approach infinity, the fluid phase temperature is larger than that of the solid phase within the part of the porous region near the interface, and smaller than that of the solid phase within the other part of the porous region, as shown in FIGS. 5A-5D. This results a changing of the direction of heat exchange between the solid and fluid phases.

The maximum relative temperature difference between solid and fluid phases within the porous region is computed as follows:

$$\% Δ θ = \frac{max \vert {θ}_{s} - {θ}_{f} \vert}{{θ}_{f} {{\vert}_{η = 1} - {θ}_{f} \vert}_{η = 0}} \times 100 \qquad Eq . ( 65 )$$

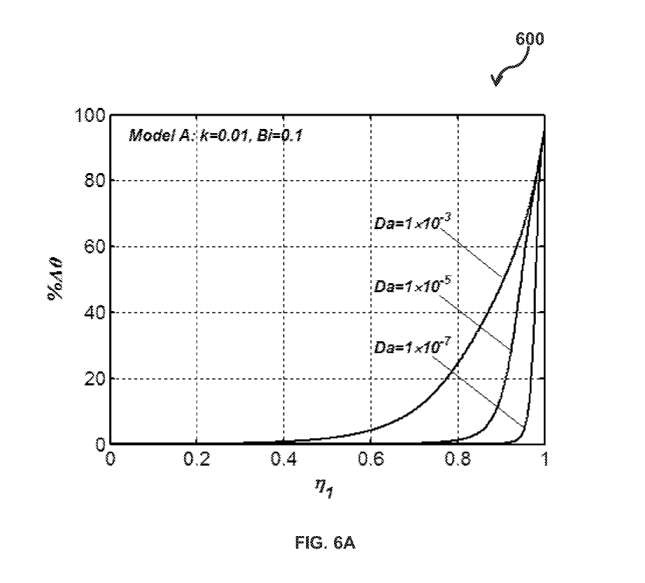

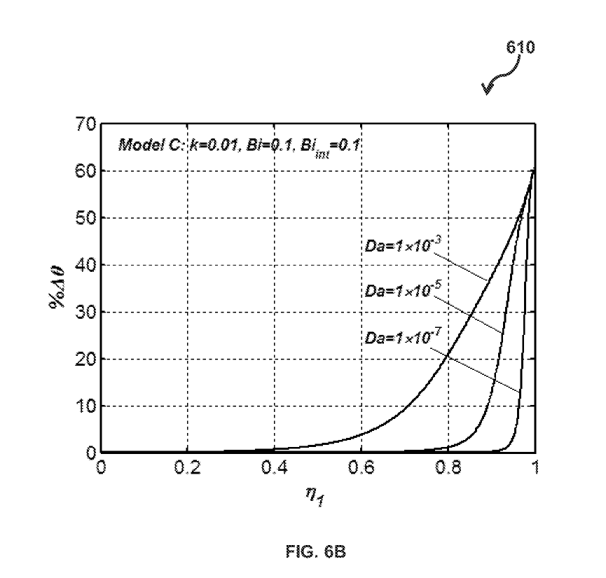

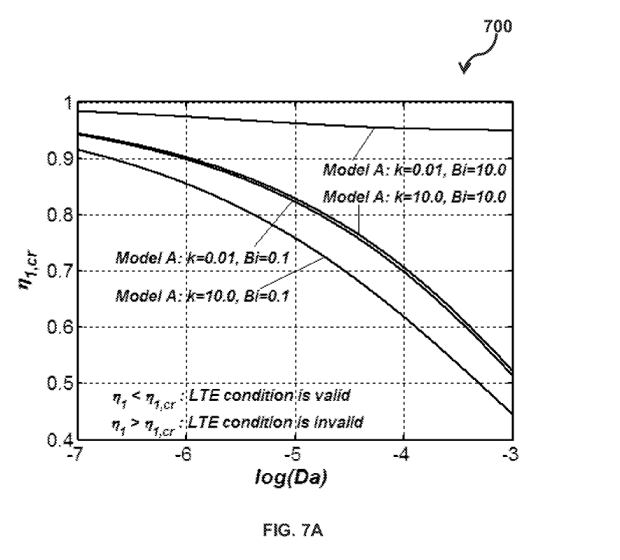

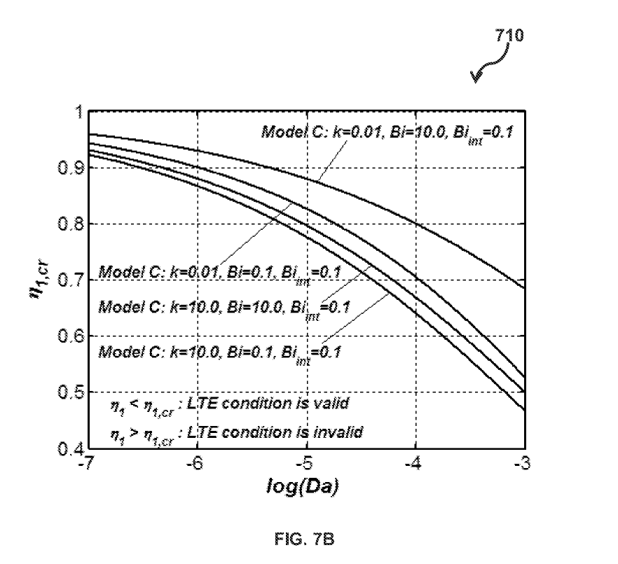

The variable %Δθ varies as a function of ill as shown in FIG. 6. This figure reveals that the maximum relative temperature difference between solid and fluid phases increases as η₁ and Da become larger. To examine the LTE condition, a critical η_{1,cr} is introduced as displayed in FIGS. 7A-7B, at which the maximum relative temperature difference between solid and fluid phases within the porous region is within a small percentage difference. This small percentage difference is chosen to be two percent. That is:

%Δθ|_{η}_{₁}_{=η}_{_{1,cr}} Eq. (66)

FIGS. 6A-6B illustrate graphs 600 and 610 showing %Δθ variations as a function of η₁ for α*=0.78 and ε=0.9. FIGS. 6A-6B demonstrates that when η₁>η_{1,cr}, % Δθ>2.0, thus the LTE condition is considered to be invalid and when η₁<η_{1,cr}, %Δθ<2.0, thus the LTE condition is considered to be valid.

FIGS. 7A-7B displays graphs 700 and 710 showing the η_{1,cr} variations as a function of pertinent parameters k, Bi, Biᵢₙₜ, and Da. It is found that η_{1,cr} increases as Bi becomes larger or k becomes smaller. When η₁ is small enough, the LTE condition is valid even for a small Bi, which can translates into a weak internal heat transfer between the fluid and solid phases. On the other hand, when η₁ is large enough, the LTE condition is not valid even for a large Bi. When Da becomes small, η_{1,cr} will increase. The reason for this is that less energy will be transferred into the porous region as Da decreases. Comparing between FIGS. 7A-7B, it is found that Biᵢₙₜ has an important influence on η_{1,cr}. For example, when k=0.01 and Bi=10, different Biᵢₙₜ will result in quite different η_{1,cr} distributions.

### 3.4. Nusselt Number Results

The non-dimensional bulk mean temperature of the fluid can be calculated as:

$${θ}_{f , b} = \frac{{\int }_{0}^{1} {θ}_{f} ( η ) U d η}{{U}_{m}} \qquad Eq . ( 67 )$$

The wall heat transfer coefficient and the Nusselt number are obtained from following equations:

$$\begin{matrix}{h}_{w} = \frac{{q}_{w}}{{T}_{f , w} - {T}_{f , b}} & Eq . ( 68 ) \\ Nu = \frac{{h}_{w} ( 4 H )}{{k}_{f}} = \frac{4}{{k}_{1} ( {θ}_{f , w} - {θ}_{f , b} )} & Eq . ( 69 )\end{matrix}$$

wherein 4H is the hydraulic diameter of the channel.
Nusselt number for interface condition of Model B

Substituting equations (25), (26), (49), and (51) in equations (67) and (69), results in:

$$\begin{matrix}\begin{matrix} Nu = \frac{{h}_{w} ( 4 H )}{{k}_{f}} \\ = \frac{4}{{k}_{1} [ \begin{matrix}{{D}_{0} ( 1 - {η}_{1} )}^{4} + {{D}_{1} ( 1 - {η}_{1} )}^{3} + {{D}_{2} ( 1 - {η}_{1} )}^{2} + \\ {D}_{3} ( 1 - {η}_{1} ) + {θ}_{f} ( {η}_{1}^{-} ) - {θ}_{f , b}\end{matrix} ]}\end{matrix} & Eq . ( 70 ) \\ where & \\ {θ}_{f , b} = \frac{{θ}_{f , pm} {D}_{a} {η}_{1} + {θ}_{f , om} {U}_{m , open} ( 1 - {η}_{1} )}{{U}_{m}} & Eq . ( 71 ) \\ {θ}_{f , pm} = \frac{γ}{( 1 + k ) λ sinh ( λ {η}_{1} )} [ β - k ( 1 - β ) ] [ \frac{sinh ( λ {η}_{1} )}{{λη}_{1} k} + cosh ( λ {η}_{1} ) ] - \frac{γ {η}_{1}}{3 ( 1 + k )} - \frac{γ}{( 1 + k ) {η}_{1} Bi} & Eq . ( 72 ) \\ {θ}_{f , pm} = \frac{1}{{U}_{m , open}} [ - \frac{{D}_{0}}{14} {( 1 - {η}_{1} )}^{6} + ( \frac{- 0.5 {D}_{1} + {D}_{0} {D}_{9}}{6} ) {( 1 - {η}_{1} )}^{5} + ( \frac{- 0.5 {D}_{2} + {D}_{1} {D}_{9} + {U}_{B} {D}_{0}}{5} ) {( 1 - {η}_{1} )}^{4} + ( \frac{- 0.5 {D}_{3} + {D}_{2} {D}_{9} + {U}_{B} {D}_{1}}{4} ) {( 1 - {η}_{1} )}^{3} + ( \frac{- 0.5 {θ}_{f} ( {η}_{1}^{-} ) + {D}_{3} {D}_{9} + {U}_{B} {D}_{2}}{3} ) {( 1 - {η}_{1} )}^{2} + ( \frac{{θ}_{f} ( {η}_{1}^{-} ) {D}_{9} + {U}_{B} {D}_{3}}{2} ) ( 1 - {η}_{1} ) + {θ}_{f} ( {η}_{1}^{-} ) {U}_{B} ] & Eq . ( 73 ) \\ {D}_{9} = \frac{{α}^{*}}{\sqrt{Da}} ( {U}_{B} - Da ) & Eq . ( 74 )\end{matrix}$$

### Nusselt Number for Interface Condition of Model A

The Nusselt number for interface condition of Model A can be obtained by substituting β=β_{cr} in equations (70-73).

### Nusselt Number for Interface Condition of Model C

TABLE 2
Results of Spearman rank correlation coefficients test for
sensitivity analysis (sampling size: 10⁶)

| | Spearman rank | | |
|---|---|---|---|
| | correlation | | |
| Variable | coefficient | p-value | Rank |
| Da | −0.7843 | 0.00000 | 1 |
| η₁ | 0.2446 | 0.00000 | 2 |
| κ | −0.1461 | 0.00000 | 3 |
| Bi | 0.0611 | 0.00000 | 4 |
| Biᵢₙₜ or β | 0.0438 | 0.00000 | 5 |
| ε | 0.0220 | 0.00000 | 6 |
| α* | −0.0007 | 0.61187 | 7 |

The Nusselt number for interface condition of Model C can be obtained by substituting β=1−D₈Biᵢₙₜη₁ in equations (70-73). Since there are many parameters which will influence the heat transfer performance, a sensitivity analysis according to the Spearman Rank Correlation Coefficients method based on Monte Carlo sampling is implemented to show the relative importance of various parameters before discussing the Nusselt number results. As can be seen in Table 2, Da, η₁, and k have a strong influence on the Nusselt number; Bi, Biᵢₙₜ, β, and ε have a moderate influence on the Nusselt number, while α* has a weak influence on the Nusselt number.

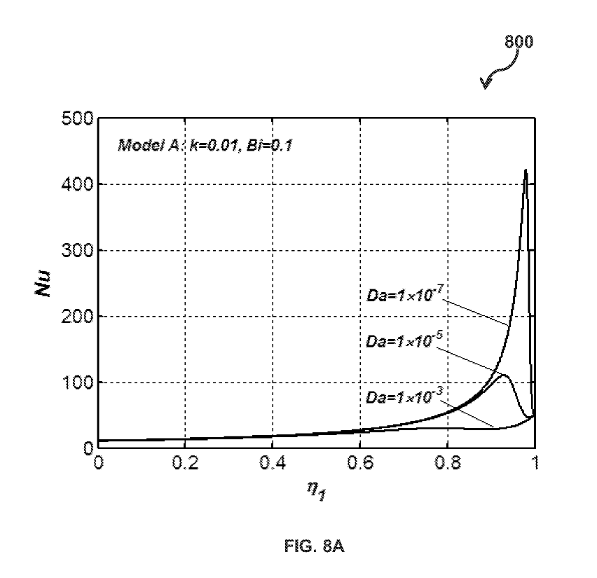

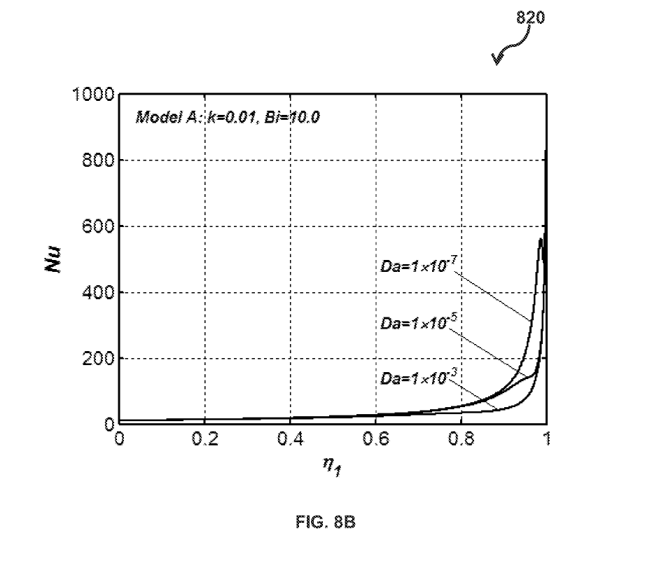

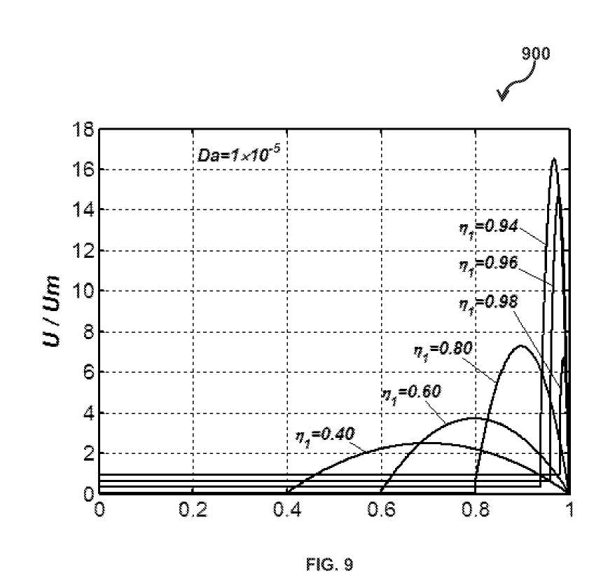

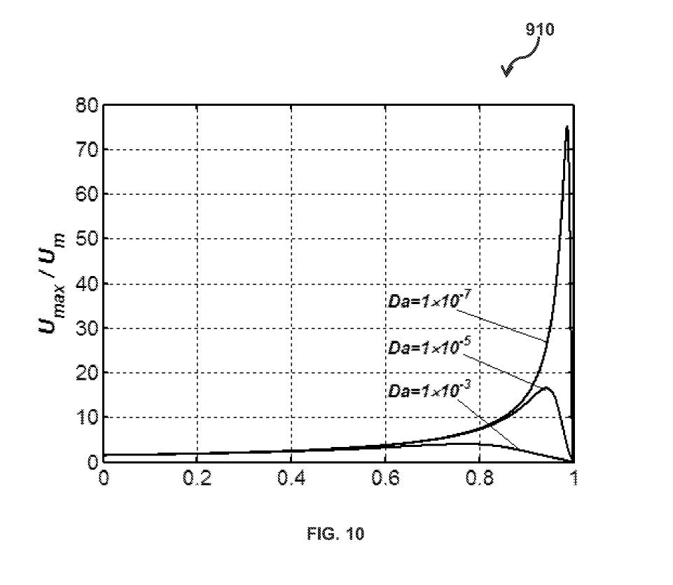

FIGS. 8A-8B presents the variations of the Nusselt number for Model A as graphs 800 and 810. It is seen that, in general, the variations of Nusselt number as a function of η₁ can be divided into three stages. During the first stage, the Nusselt number increases as η₁ increases. After that, if η₁ continues to increase, the Nusselt number will drop. This can be referred to as the second stage. During the third stage, as η₁ increases further it will translate into the interface reaching almost to the wall. This will cause the Nusselt number to increase once again. The reason for the existence of these three stages can be explained using FIGS. 9 and 10.

FIG. 9 presents a graph 900 showing the dimensionless velocity distributions as a function of η₁. FIG. 10 present a graph 910 showing the variation of the maximum velocity at the open region for pertinent parameters η₁ and Da. It is found that, when the average velocity over the channel cross section is maintained unchanged, i.e., for the same Reynolds number, the maximum velocity at the open region will first increase and then decrease as η₁ increases from zero to one while its location will move towards the wall. The heat transfer performance within the whole channel, which can be represented by the Nusselt number, is dependent on both the heat transfer characteristics of the porous region and that of the open region.

During the first stage, an increase of the maximum velocity at the open region with η₁ results in a heat transfer enhancement at the open region. In the meantime, as shown in FIG. 4, since only a small amount of energy is transferred into the porous region, this will almost have no influence on the heat transfer performance within the porous region. Overall, this will result in an increase in Nusselt number. During the second stage, a decrease in the maximum velocity at the open region with η₁ results in a reduction in the heat transfer at the open region. Since only a relatively small amount of the imposed flux is transferred into the porous region, its influence on the heat transfer performance at the porous region is limited. Overall, this will result in a decrease in the Nusselt number. During the third stage, even though a drop in the maximum velocity within the open region will weaken the heat transfer at open region, there will be a heat transfer enhancement within the porous region because a large amount of energy is transferred by the porous medium, and the extensive interfacial area and tortuous flow passages within porous structure participate more actively in the heat exchange. Overall, this results in an increase in the Nusselt number. A large Da will increase the energy transferred by the porous region, and a large Bi will enhance the heat exchange between the fluid and solid phases within the porous medium. As such the heat transfer within the porous region is enhanced and the second stage of the variation of the Nusselt number will disappear, such as the case of Da=1×10⁻³ and Bi=10.0, as shown in FIG. 8B.

It is found that when α*=0 and as η₁→0, the Nusselt number will approach 8.235, which agrees well with the analytical solution for a smooth channel. On the other hand, as η₁→1, the Nusselt number will become independent of Darcy number and is just dependent on the thermal condition at the porous-fluid interface. This is because the fluid flow through the porous medium is represented by the Darcian flow model. Furthermore, if the Nusselt number is redefined as in equation (75) given below, which is the definition of Nusselt number used by Lee and Vafai, the Nusselt number calculated from Model A for η₁→1 will approach that derived by them. See Lee, D. Y., and Vafai, K., 1999, “Analytical Characterization and Conceptual Assessment Of Solid And Fluid Temperature Differentials In Porous Media,” Int. J. Heat Mass Transfer, 42, pp. 423-435.

$$Nu = \frac{{h}_{w} ( 4 H )}{{k}_{f , eff}} \qquad Eq . ( 75 )$$

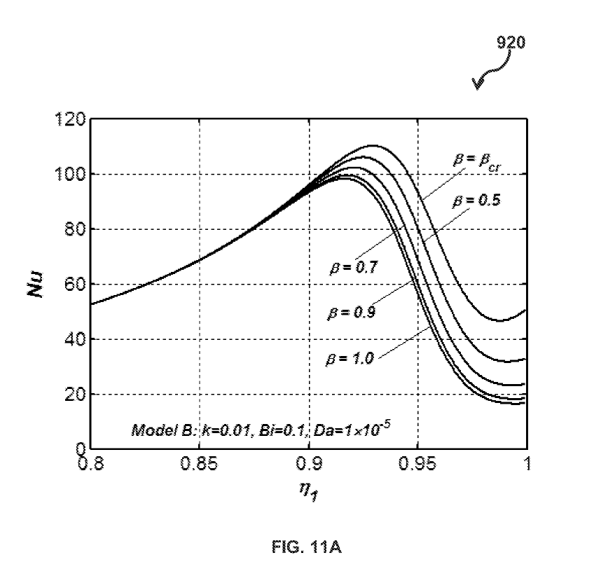

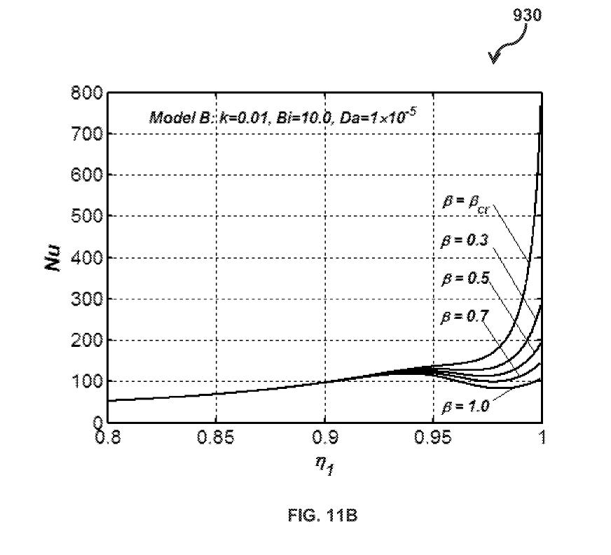

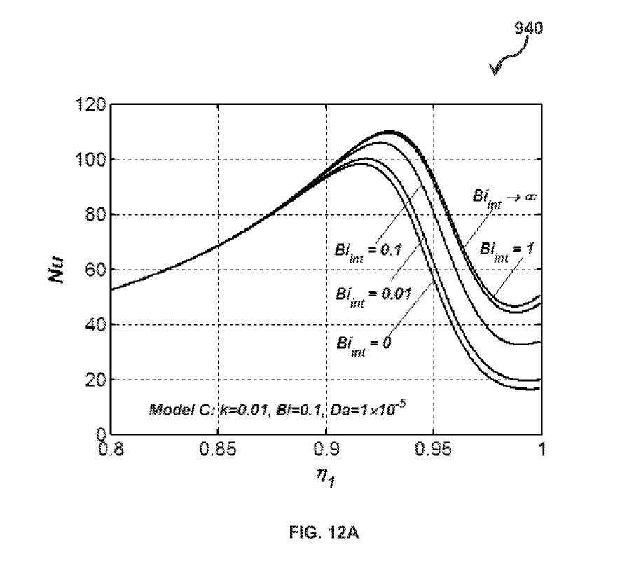

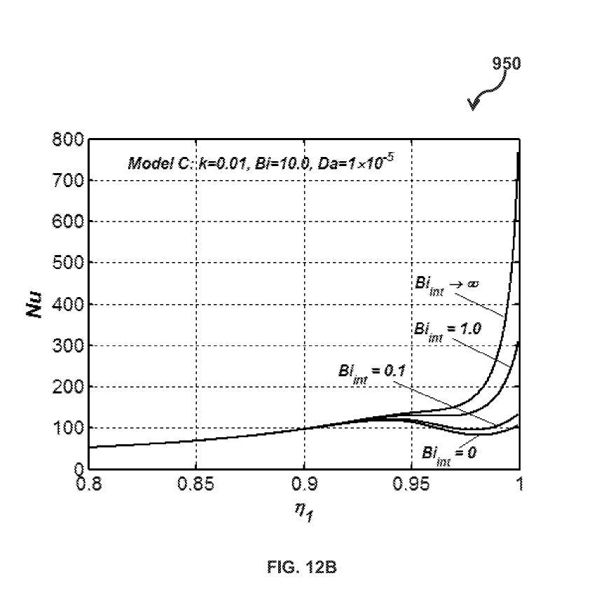

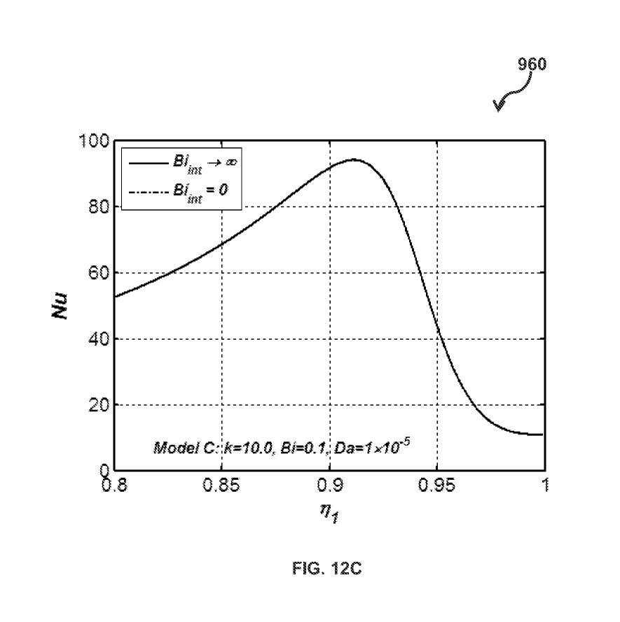

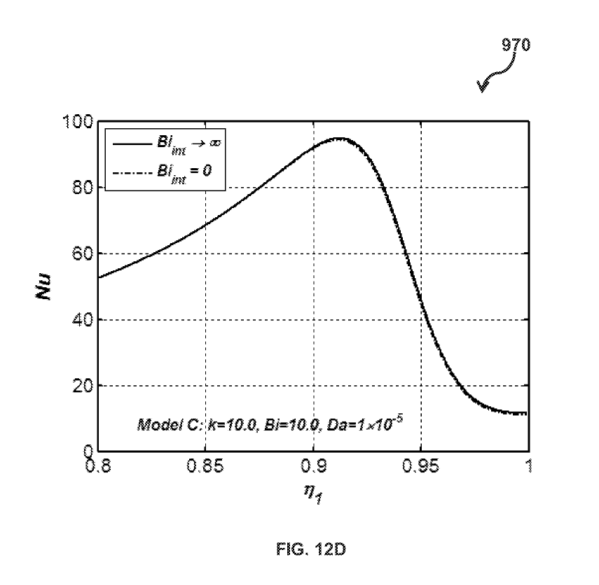

The Nusselt number variations as a function of pertinent parameters k, Bi, Biᵢₙₜ, and β for Models B and C are shown in FIGS. 11A-11B and FIGS. 12A-12D, respectively as graphs 920 and 930, and 940, 950, 960, and 970. It should be noted that the Nusselt number calculated from Model B for β=1 is also that calculated from Model C for Biᵢₙₜ=0; and the Nusselt number calculated from Model B for β=β_{cr} is also that calculated from Model A as well as the one calculated from Model C for Biᵢₙₜ→∞. When Biᵢₙₜ becomes larger or β becomes smaller, which will be translated into an enhanced heat transfer between the fluid and solid phases at the interface, more energy is transferred into the solid phase through interface. Since this energy is more effectively transferred through the porous structure, the Nusselt number will increase.

When Model A is valid, the heat transfer between the fluid and solid phases at the interface has relatively the highest enhancement, thus the maximum fraction of the total heat flux at the interface will be transferred into the solid phase at the interface. Therefore, the Nusselt number calculated from Model A will be the largest among the three models. Furthermore, when Bi becomes larger, which translates into an enhanced internal heat transfer between the fluid and solid phases within the porous region, the Nusselt number will also increase. When k is large, a relatively smaller fraction of the imposed load will be transferred into the solid phase at the interface for any of the considered models, as seen in FIG. 2. As such, the thermal conditions at the porous-fluid interface will have almost no influence on the variations of Nusselt number, as shown in FIGS. 12C-12D.

### 4. CONCLUSIONS

A comprehensive investigation of variant thermal conditions at the porous-fluid interface under LTNE condition is presented in this work. Exact solutions are derived for both the fluid and solid temperature distributions for five primary pertinent approaches (Models A, B.1, B.2, B.3, and C) for the porous-fluid interface. It is established in detail that the results obtained from these primary models can be transformed between each other. It is also found that the critical ratio of heat flux for the fluid phase to the total heat flux at the interface for Model B will provide the means for establishing its range of validity. The range of validity of all the models has been analyzed with respect to the disclosed embodiments.

Also a critical non-dimensional half height of the porous media is determined, below which the LTE condition within porous region is considered to be valid. A comprehensive discussion of the three stages of variation of Nusselt number as a function of the height of the porous media which is dependent on both the heat transfer characteristics of the porous region and that of open region is presented. Among the three interface thermal models, the Nusselt number calculated from Model A is shown to produce the largest values. Furthermore, the analytical results have been verified with several limiting cases. The agreement with the limiting cases is excellent.

It will be appreciated that variations of the above disclosed apparatus and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A method for analyzing variant thermal conditions at a porous-fluid interface under a local thermal non-equilibrium condition, said method comprising;
deriving a plurality of exact solutions for a fluid and at least one solid temperature distribution at an interface between a porous medium and a fluid medium;
analyzing relationships among said plurality of exact solutions;
analyzing a range of validity of various thermal interface conditions; and
deriving a Nusselt number for said fluid at a wall of a channel that contains said fluid medium and said porous medium in order to obtain effects of pertinent parameters with respect to said interface under local thermal non-equilibrium conditions.

2. The method of claim 1 further comprising analyzing a range of validity of a LTE condition with respect to said porous-fluid interface.

3. The method of claim 1 wherein said pertinent parameters include a Darcy number.

4. The method of claim 1 wherein said pertinent parameters include a Biot number.

5. The method of claim 1 wherein said pertinent parameters include an Interface Biot number.

6. The method of claim 1 wherein said pertinent parameters include a fluid-to-solid thermal conductivity ratio.
